(19) United States
(12) Patent Application Publication
(10) Pub. No.: US 2009/0302564 A1
(43) Pub. Date: Dec. 10, 2009

(54) Human powered multi-functional pet transport cart

(76) Inventors: Timothy J. Evans, Ben Lomond, CA (US); Janet M. Evans, Ben Lomond, CA (US)

Correspondence Address: John E. Menear, #4, 1200 Capitola Road, Santa Cruz, CA, 95062, US

(21) Appl. No.: 12/157,269

(22) Filed: Jun. 9, 2008

(51) Int. Cl. B62B 7/00; A01K 29/00

(52) U.S. Cl. 280/47.38; 119/28.5

(57) ABSTRACT

A human powered multi-functional pet cart for transporting pets or animals. This invented cart is particularly beneficial for pets with health problems, but may be used with any pet. A riding bed, which is 1 to 12 inches above ground, enables easy entrance and exit for animals with mobility problems. An accessory station with an extension bar permits a variety of pet accessories to be carried over the riding bed. Pet accessories can be carried which address comfort, standard necessities, or special pet needs. The use of a detachable front wheel assembly allows the cart to fit into a small vehicle for remote use. Padded floors and sidewall windows are designed make the riding more enjoyable for the pet.

### CROSS-REFERENCE TO RELATED APPLICATIONS

Not Applicable

### STATEMENT REGARDING FEDERALLY SPONSORED RESEARCH

Not Applicable

### REFERENCE TO A MICROFICHE APPENDIX

Not Applicable

### BACKGROUND OF THE INVENTION

1. Field of the Invention

This invention relates to carts, carriers, or strollers which are designed to transport pets or animals. In particular, the cart provides for the pet's needs and comfort.

Carts can be designed to utilize an animal's power or a human's power. The instant invention uses human power.

2. Description of Related Art

Carts to transport pets or animals are known in the prior art. Prior art pet carts include wheels, a platform which holds the animal, and a method of moving the cart.

The method of moving may incorporate human power or animal power.

An example of an animal powered cart is a cart designed for a dog with normal front legs and missing hind legs. The dog's rear torso is attached to a structure with set of wheels, and the dog moves the wheeled structure with its front legs. The wheels substitute for the loss of hind legs. This dog powered cart provides mobility to a dog that otherwise could not join its owner for a walk.

For an animal with normal back legs and missing front legs, a similar strategy is available. In this case, the wheels are positioned at the animal's front torso.

An animal powered cart is primarily applicable to animals that are healthy except for a disability acquired via accident. But it is less applicable to animals that are sick or have breathing difficulty or have joint pain.

For less healthy animals, a human powered cart is preferred. Concerned pet owners consider their pets as part of the family, and owners want their pets to travel with them. An animal's infirmity does not diminish the bond between owner and pet.

A common example of a human powered cart is a child giving his pet a ride in a wagon. The wagon's bed forms the platform for the animal, and the wagon's handle provides a method of moving.

It is important to note that human powered carts are not limited to animals with failing health. The pet in the child's wagon may be a vibrant young animal. The current invention may be used with any pet, regardless of health.

Prior art human powered carts have shortcomings. The comfort of the pet, specific needs of the pet, the ability to use the cart distant from home, and the ability to carry accessories have not been addressed in the prior art.

For example, the riding bed of a wagon is typically metal or hardwood. An animal with joint restriction feels pain when the wagon is pulled over a bumpy road. Or an animal with long hair would become overheated on a 90 degree F. day if the riding bed is not shaded.

In another shortcoming of human powered prior art carts, the cart may not have detachable wheels. Hence, the cart must be loaded into the family vehicle in one piece. The cart may not fit, particularly when other luggage is present.

Accessories to accommodate special pet needs are another shortcoming of prior art carts. For example, an animal may be incontinent. So, easy cart cleaning becomes important. Or an animal may require medicine. So, the capability to suspend an intravenous medicine container is needed.

Some prior art carts may provide a remedy for one or two of the above cited shortcomings. But no prior art cart provides a comprehensive solution for comfortable, considerate and functional pet transport.

A need exists for a cart that provides a versatile and comprehensive approach to transporting pets. This cart should accommodate pets with health problems, as well as healthy animals. The cart frame should be sturdy enough to carry large animals.

### BRIEF SUMMARY OF THE INVENTION

The invented multi-functional pet cart employs features from the prior art, and adds new features (and capabilities) that provide a new approach to pet or animal transport. The novelty of this instant invention lies in the unique combination of structural features.

With the invented multi-functional pet cart, the comfort of the animal, consideration of special needs, easy cart assembly and disassembly, plus accessory utilization are combined into one fully functional apparatus.

A cart frame provides both stability and weight carrying capacity. Frame strength arises from incorporation of metal box tubing and metal strap. The frame is further structured to provide a base for unique functionality. The functionality extends the cart's application to all pets, regardless of health.

The invented cart has at least three wheels, positioned such that the cart cannot tip over easily. Common embodiments include one front wheel and two rear wheels, or one rear wheel and two front wheels.

When three wheels are employed, the riding bed (which holds the pet) is contained within an area defined by the three wheels. This means that regardless of pet or animal movement within the riding bed, the center of gravity remains within the wheel base, and the cart is unlikely to tip over.

An essential feature of the multi-functional pet cart is a detachable front wheel assembly, of which the front wheel is a component. It is important to note that the front wheel assembly can be attached to (or removed from) the cart frame without the use of tools (such as a screwdriver or wrench).

The detachable front wheel assembly confers two functional benefits. Speed of attachment or detachment is the first benefit of the detachable wheel assembly. The second benefit of the detachable wheel assembly is space savings.

In a variation with one front wheel and two rear wheels, the connection between the frame and the front wheel assembly embodies rotation. Rotation allows the front wheel, to turn right and left, and facilitates easy steering.

Another essential feature of the multi-functional cart is an accessory station, which is designed to mate securely onto the cart frame. The accessory station permits the attachment of pet accessories which accommodate an animal's special needs. Note that the pet accessories are specific to pets, as opposed to humans, plants, or inanimate objects.

A pet umbrella, when attached to an accessory station, protects a pet from overheating in the sun. The pet umbrella also protects a pet from rain. A pet support sling may be used to transfer an animal's weight from its legs to its torso. For an animal with foot pain, transferring weight from the feet to torso provides comfort and healing support.

A pet cleanup tool or a pet cleanup bag is useful for an older animal that accidentally loses bowel control.

An accessory station attaches to the frame with accessory station fittings. For stability of the accessory station, two attachments to the frame are useful since two attachments restrict the tendency to twist. In most cases, two attachments to the frame are used.

Accessory station fittings disposed at low elevation (on the frame) transfer the weight of the accessory station to a low center of gravity, which leads to improved control and stability. The number and elevation of accessory station fittings to the frame may vary, and remain within the scope of this invention.

Another essential feature of the multi-functional pet cart is a riding bed. A riding bed includes a floor and sides. The pet is located within the riding bed during pet transport.

When the cart is used for an infirm animal, sides with windows are functional. Sides prohibit the pet from falling out, and the windows allow the pet to look out without standing up. For pet entry, either one side is removable or one side contains a door.

In one design, the floor of the riding bed is carpeted or padded. In other variations, (a) the sides are padded or (b) the sides plus floor are padded.

Locating pins or locating tabs are integrated into the frame, and define the position of the riding bed on the frame. Due to the locating pins or locating tabs, riding beds are inter-changeable without the need for tools. Neither a wrench nor screwdriver is necessary to change riding beds.

Brakes on one or more of the wheels is useful on hills, where otherwise the cart speed could unintentionally increase. Brakes are an option.

Objects of this invented pet or animal cart include:
(a) incorporate a standard cart frame that can support at least 70 pounds or a heavy duty frame that can support at least 200 pounds,
(b) use at least three wheels,
(c) provide a front wheel assembly (which holds a front wheel) that can be attached or detached from the cart frame without the use of tools,
(d) if only one front wheel is used, provide a swivel joint option for the front wheel assembly that contributes to easy steering,
(e) use a riding bed (to hold the animal or pet) that has sides and a floor, where one side is removable or one side contains a door,
(f) connect an accessory station to the cart frame using accessory station fittings located on the frame,
(g) utilize an extension bar, which is a component of an accessory station, to support accessories over a riding bed,
(h) provide accessory holders for attaching accessories to an extension bar, and
(i) carry pet accessories which address the special needs of the pet or animal.

### BRIEF DESCRIPTION OF THE SEVERAL VIEWS OF THE DRAWINGS

FIG. 1A illustrates a partially-assembled multi-functional pet cart with structural elements connected to the frame. A rear accessory station is present. Two positions for a front accessory station are shown while not in use. A riding bed is absent.

FIG. 1B illustrates another partially-assembled multi-functional pet cart with structural elements connected to the frame. A rear accessory station is present, and a front accessory station is also present.

FIG. 2 shows a riding bed in position for animal transport.

FIG. 3 shows a fully-assembled multi-functional pet cart. The fully-assembled multi-functional pet cart includes a frame, a riding bed, a pet accessory station, accessory holders that join pet accessories to an extension bar, example pet accessories, and a detachable front wheel assembly.

FIG. 4 shows several accessory holders connected to an extension bar.

FIG. 5 shows an alternative method of attaching a pet umbrella to a multi-functional pet cart. In this alternative method, the pet umbrella is secured to a side of the cart rather than to an accessory station.

### DETAILED DESCRIPTION

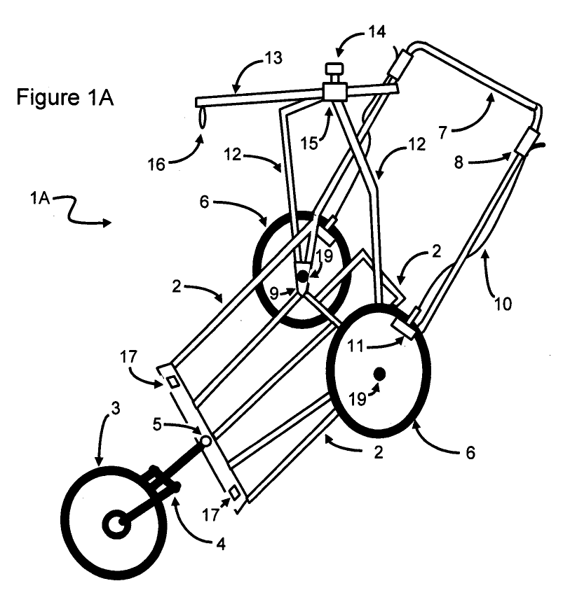

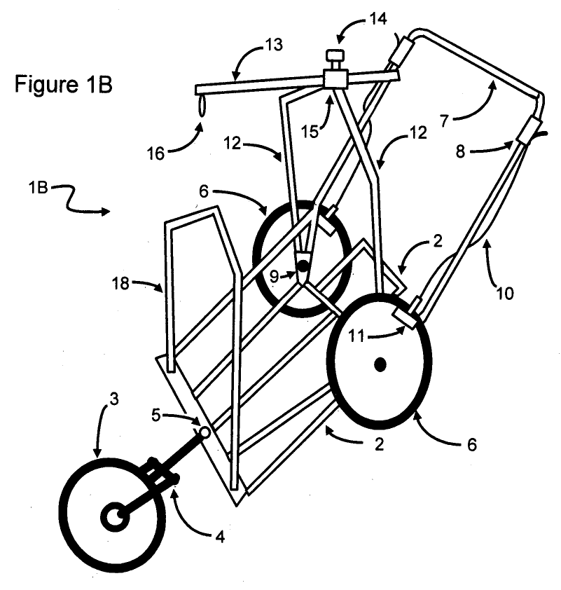

FIG. 1A illustrates an embodiment of a partially-assembled multi-functional pet cart 1A. It includes a rear accessory station 12 and a detachable front wheel assembly 4. The partially-assembled multi-functional pet cart 1A is viewed from a top/right perspective. For clarity and labeling of structural features, a riding bed has been omitted.

The weight of the multi-functional pet cart is supported by the frame 2 and three or more wheels 3,6.

The frame 2 is a fundamental required feature of the instant invention, and is formed mostly or fully from metal box tube and metal strap. In this embodiment, welding is used to interconnect the metal box tube and metal strap. Welding provides excellent strength, minimizes frame vibration, and reduces frame noises.

However, interconnection with nuts and bolts, or other fittings, is within the inventive concept. When fittings are used for interconnection, periodic frame maintenance is appropriate to maintain rigidity.

The partially-assembled multi-functional pet cart 1A has a detachable front wheel assembly 4 which includes a front wheel 3. For the instant invention, a detachable front wheel assembly 4 is a required feature to achieve the full utility of the multi-functional pet cart.

Although two detachable front wheels assemblies may be used, one detachable front wheel assembly 4 is typical.

In the FIG. 1A embodiment, the front wheel assembly 4 can be attached to (or detached from) the cart frame without the use of tools, such as a screwdriver or wrench.

Attaching the front wheel assembly 4 to the frame 2 is accomplished via two segments of box tube, where a smaller box tube section slides into the opening of a larger box tube. Each box tube segment has one or more alignment holes 5. A pin slides through an alignment hole 5, and secures the detachable front wheel assembly 4 to the frame 2.

Alternately, a large diameter knob with a screw passes through the alignment hole 5 and into a nut that is welded onto the outside of an alignment hole 5. For extra safety, both (a) a pin and (b) a knob with a screw may be used together.

A swivel joint (not shown) may be optionally included into the detachable front wheel assembly 4 to facilitate turning the front wheel.

Speed is the first benefit of the detachable wheel assembly 4. Compared to detaching and attaching a front wheel that is not contained within an assembly, the operation is quick and uncomplicated. A simple pulling or twisting motion is sufficient to effect the separation.

A second benefit of the detachable wheel assembly 4 is space savings. When disassembled, a multi-functional pet cart is shortened by the length of the detachable front wheel assembly 4. Note that the length of the detachable front wheel assembly 4 is greater than the diameter (two radii) of the front wheel 3. In contrast, removing a front wheel 3 would only shorten a multi-functional pet cart by a length equal to one wheel radius. The multi-functional pet cart, with front wheel assembly removed, fits into a smaller vehicle cargo space than would be possible with front wheel 3 removal alone.

Human power is applied through the handlebar 7 which is attached to the frame 2 at an interface plate 9. For control, the embodiment in FIG. 1A also has hand brakes 8 which apply braking to the rear wheels 6 via brake cables 10. Braking pads 11 slow the rotation of the rear wheels 6 with friction. Braking is an option.

The rear wheels 6 attach to the frame 2 at interface plates 9. Rear wheel axles 19 or extensions to the rear wheel axles 19 pass through the interface plate 9.

A rear accessory station 12 is incorporated into the partially-assembled multi-functional pet cart 1A. The rear accessory station fittings (not visible in FIG. 1A) join the rear accessory station 12 to the frame 2 at interface plates 9. The rear accessory station fittings comprise a section of box tube that has been welded to the interface plate 9.

The lower segment of the rear accessory station 12 in this embodiment is formed from box tube that is larger than the rear accessory station fittings. The larger box tube slides over the smaller box tube to mate the rear accessory station 12 to the interface plate 9.

The rear accessory station 12 connects at two frame locations to increase rigidity and minimize twist. Two front accessory station fittings 17 enable the attachment of a front accessory station (not shown) or two accessory posts (not shown) that can also be used to hold pet accessories.

The rear accessory station 12 includes an extension bar 13 and a bushing 15 with an adjustment screw 14 that permits adjustment of the extension bar 13.

Accessory holders, such as a carabineer 16, are used to secure pet accessories to the extension bar 13 or to accessory posts.

FIG. 1B is shows a similar partially-assembled multi-functional pet cart 1B. A front accessory station 18 has been added. Front accessory station fittings are not visible since the front accessory station 18 fits over the front accessory station fittings 17 (that are visible in FIG. 1A). The front accessory station 18 may include a separate extension bar, but a separate extension bar isn't necessary.

When a rear accessory station 12 and a front accessory station 18 are used simultaneously, an extension bar 13 may be connected to both accessory stations 12, 18. This is particularly useful when a pet's weight is supported by a sling suspended from the extension bar 13, and a strong base of support is needed.

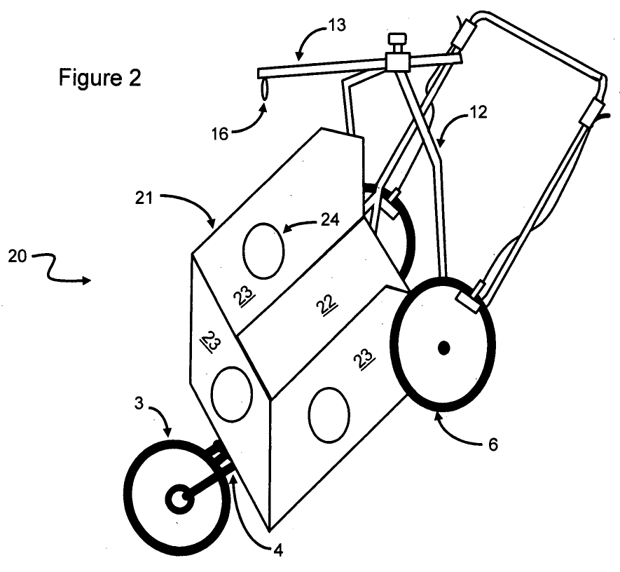

FIG. 2 illustrates a partially-assembled multi-functional pet cart 20 where a riding bed 21 has been placed onto the frame. During pet transport, the pet rides within the riding bed 21. As drawn, three sides 23, three windows 24, and a floor 22 are shown.

A fourth side, corresponding to the rear of the riding bed 21, is a removable side that has been removed. The fourth side is not shown. When the removable side is absent, a pet can enter or leave the cart. Even a pet with limited mobility can enter or leave the cart because the floor 22 of the riding bed 21 is disposed 1 inch to 12 inches above the road or sidewalk. Alternately stated, the riding bed 21 is located 1 inch to 12 inches above the bottom surface of the wheels 3,6.

Instead of a removable side, a door in one of the sides 23 can accomplish the same goal. The pet then enters and leaves through the door.

A window 24 allows the pet to see outside the cart. Visibility through the window 24 is functional for a small pet or a pet that has difficulty standing.

Padding on the floor 22, the sides 23, or both is added for pet comfort. A pet with hurt ribs experiences a smoother ride when bumps in the road are absorbed by the padding. In some embodiments, typical household carpeting and padding are used.

The riding bed 21 rests on the frame and is secured by positioning tabs or pins, rather than by screws, bolts, or nuts. This makes changing the riding bed easy because no screwdriver, wrench, or other tool is required. One riding bed is lifted out, and another is lowered onto the frame.

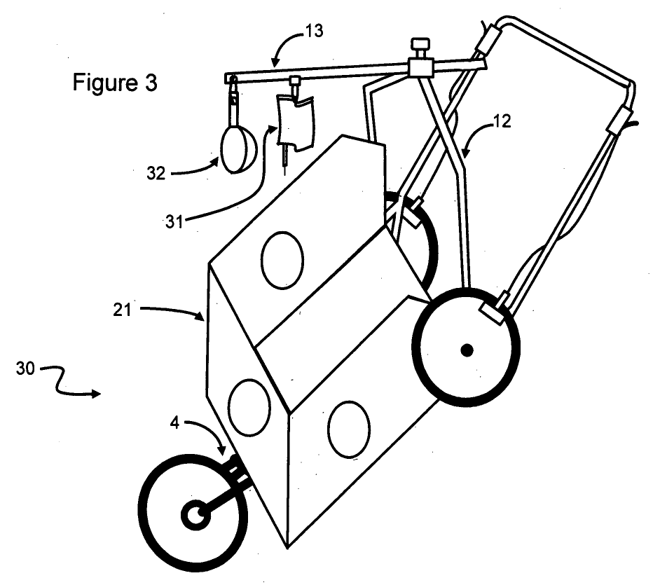

FIG. 3 shows a fully-assembled multi-functional pet cart 30. It includes a riding bed 21 positioned on a frame, a rear accessory station 12, an extension bar 13, and a detachable front wheel assembly 4. A pet intravenous injection bag 31 and a pet feeding bowl 32 are shown as example pet accessories. Other examples of pet accessories include a pet umbrella, a pet support sling, a pet clean-up tool, a pet clean-up bag, a pet water bottle, a pet leash, a pet first aid kit, a pet medication bottle, a pet walking cane, a pet sweater, a pet play toy, and a pet food tray. This listing is not a complete listing, and other pet accessories may be attached.

Note that pet accessories are specific for pets or animals, as opposed to humans, plants, or inanimate objects. This is important since an accessory station that supports pet accessories is a necessary element of the instant invention. The limitation that pet accessories are specific for pets or animals structurally differentiates the accessory stations for the multifunctional pet cart from accessory stations that could be used for humans, plants, or inanimate objects.

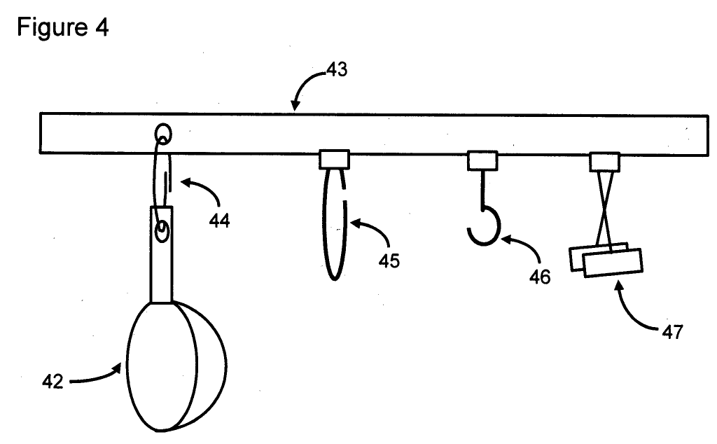

FIG. 4 shows typical accessory holders for joining pet accessories to an extension bar 43. A feeding bowl 42 is attached to the extension bar 43 with a split ring 44, which passes through an opening in the handle of the feeding bowl 42 and through an opening in the extension bar 43.

Other accessory holders for attaching pet accessories to an extension bar 43 include an open ring 45, a hook 46, a clamp 47, and a swivel hook. These examples do not represent a complete list. Accessory holders may be permanently positioned on the extension bar 43 by welding. Alternately, they can be attached with removable fittings or holes. When the extension bar 43 is slotted along its length, accessory holders may be stationed flexibly along the slot.

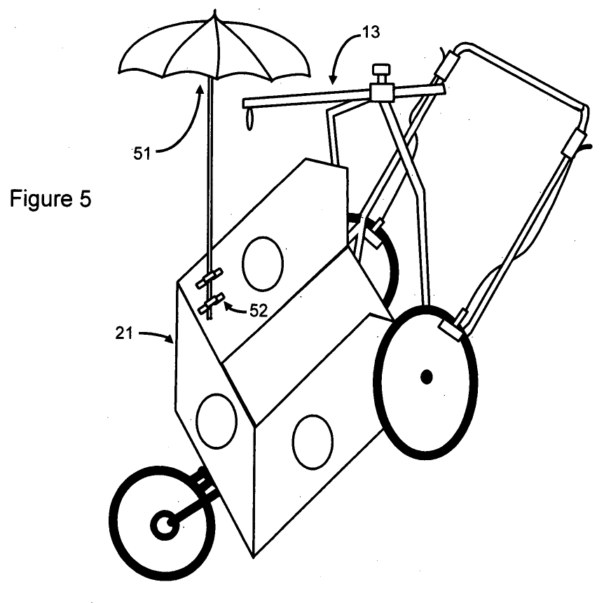

FIG. 5 shows an alternative placement of a pet umbrella 51. Rather than connecting the pet umbrella 51 to an extension bar 13, the pet umbrella 51 is connected to a side of the riding bed 21 with umbrella clamps 52. On windy days, umbrella clamps 52 provide a stable connection. The use of umbrella clamps 52 also frees positions on the extension bar 13 for other pet accessories.

It is understood that FIGS. 1-5 describe specific embodiments of a multi-functional pet cart. Details included in the embodiments address how to make and use the invented multi-functional pet cart. Details are not intended to limit the scope of the invention unless specifically cited as necessary or essential to the invention. Variations of connection methods, frame construction, and shapes are clear to of one of ordinary construction skills.

We claim:

1. A human-powered cart for transporting a pet or animal comprising:
a frame capable of carrying at least 70 pounds;
a riding bed that is carried by said frame
that contains said pet or animal during said transporting, and
that includes sides and a floor;
three or more wheels including
at least one rear wheel, and
at least one front wheel assembly,
which includes a front wheel, and
which is detachable from said frame without using a wrench or screwdriver;
at least one accessory station that includes an extension bar,
where said accessory station fits onto accessory station fittings that are disposed on said frame, and
where accessory holders join pet accessories to said extension bar.

2. Claim 1 where said cart incorporates one said front wheel and two said rear wheels.

3. Claim 1 where said frame includes metal box tubes or metal straps.

4. Claim 1 where said frame is further capable of carrying at least 200 pounds.

5. Claim 1 where said floor of said riding bed is disposed at a height of 1 inch to 12 inches above the bottom surface of said rear wheels or the bottom surface of said front wheels.

6. Claim 1 where said floor of said riding bed is carpeted.

7. Claim 1 where said floor of said riding bed includes a drain hole.

8. Claim 1 where any said side of said riding bed includes a window.

9. Claim 1 where said riding bed includes at least one said side that is removable or at least one said side that includes a door.

10. Claim 1 where said front wheel assembly contains a swivel joint that allows turning of said front wheel to the right or left.

11. Claim 1 where said front wheel assembly is attached to said frame with a pin or a knob with screw that passes through alignment holes.

12. Claim 1 where said pet accessories comprise any one selected from a group consisting of a pet umbrella, a pet support sling, a pet clean-up tool, a pet clean-up bag, a pet water bottle, a pet leash, a pet first aid kit, a pet intravenous bag, a pet medication bottle, a pet walking cane, a pet sweater, a pet play toy, and a pet food tray.

13. Claim 1 further including brakes that apply braking to said rear wheels.

14. Claim 1 where said riding bed is held with positioning pins or positioning tabs, and is removable from said frame without the use of a wrench or screwdriver.

15. Claim 1 where said accessory station fittings for said accessory station comprise metal tubes of predetermined cross-section that slide into a larger cross-section opening or slide over a smaller cross-section opening.

16. A method of transporting a pet or animal in a human-powered cart that includes a frame, a riding bed, one or more rear wheels, at least one detachable front wheel assembly, at least one accessory station, and at least one pet accessory comprising:
attaching said front wheel assembly to said cart with a pin or knob with screw;
connecting said accessory station to said frame with two or more accessory station fittings;
securing said pet accessory onto said accessory station with an accessory holder;
opening said riding bed by removing a side or by opening a door;
placing said pet or animal into said riding bed;
closing said riding bed, and
pushing said cart.

17. Claim 16 further comprising:
supporting a portion of the weight of said pet or animal within said riding bed with a sling or harness that is secured to said accessory station.

18. Claim 16 where said pet accessory comprises any one selected from a group consisting of a pet umbrella, a pet support sling, a pet clean-up tool, a pet clean-up bag, a pet water bottle, a pet leash, a pet first aid kit, a pet intravenous bag, a pet medication bottle, a pet walking cane, a pet sweater, a pet play toy, and a pet food tray.

19. Claim 16 where said frame includes metal box tubes or metal straps and said frame is capable of carrying at least 70 pounds.

20. Claim 16 where said cart includes brakes that apply braking to said one or more rear wheels.
